(19) United States
(12) Patent Application Publication
(10) Pub. No.: US 2026/0343018 A1
(43) Pub. Date: Oct. 29, 2026

(54) REGRESSIVE-BASED AFFINE BI-PREDICTION WEIGHTS

(71) Applicant: INTERDIGITAL CE PATENT HOLDINGS, SAS, Paris (FR)

(72) Inventors: Philippe BORDES, Laille (FR); Franck GALPIN, Thorigne-Fouillard (FR); Kevin REUZE, Rennes (FR); Edouard FRANCOIS, Bourg des Comptes (FR); Ya CHEN, Rennes (FR)

(21) Appl. No.: 19/491,119

(22) PCT Filed: Jun. 3, 2024
(86) PCT No.: PCT/EP2024/065164

§ 371 Date: Dec. 8, 2025

(30) Foreign Application Priority Data
Jun. 13, 2023 (EP) 23305940.1
Nov. 21, 2023 (EP) 23307010.1

(51) Int. Cl. H04N 19/577; H04N 19/132; H04N 19/136; H04N 19/176

(52) U.S. Cl. CPC H04N 19/577; H04N 19/132; H04N 19/136; H04N 19/176

(57) ABSTRACT

Bi-prediction with un-equal weights varying spatially over a current block is achieved with weights which can be derived using a regression-based model computed with at least one template made of neighboring reconstructed samples. The bi-prediction can be used with geometric partition mode blocks with different motion vectors per sub-block. The regression aims at minimizing a distance between reconstructed samples of the template and prediction samples of the template derived from two uni-prediction templates.

### CROSS REFERENCE TO RELATED APPLICATION

This application claims the benefit of European Serial Nos. 23305940.1 filed Jun. 13, 2023 and 23307010.1 filed Nov. 21, 2023, which is incorporated by reference herein in its entirety.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for video encoding or decoding, and more particularly, to a method or an apparatus for coding or decoding using regressive-based affine bi-prediction weights.

According to a first aspect, there is provided a method. The method comprises steps for determining weighting parameters for a sample of a block of video based on a template of samples neighboring the block of video; performing weighted bi-prediction of the sample using said determined weighting parameters; and, encoding the block of video using said weighted bi-predicted sample.

According to a second aspect, there is provided another method. The method comprises steps for determining weighting parameters for a sample of a block of video based on a template of samples neighboring the block of video; performing weighted bi-prediction of the sample using said determined weighting parameters; and, decoding the block of video using said weighted bi-predicted sample.

According to another aspect, there is provided an apparatus. The apparatus comprises a processor. The processor can be configured to encode a block of a video or decode video data by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, video data or a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a geometric split line description.

FIG. 2 illustrates neighboring 4×4 subblocks used for RMVF parameter derivation (W and H represent width and heigh, respectively, of block).

FIG. 3 illustrates inputs to the regression-based process, with only 1 of 2 reference blocks used for the bi-prediction.

FIG. 4 illustrates an example of subblock based prediction of a coding unit.

FIG. 5 illustrates use of top and left reference subblock templates for deriving weighting parameters.

FIG. 6 illustrates a standard, generic, video compression scheme.

FIG. 7 illustrates a standard, generic, video decompression scheme.

FIG. 8 illustrates a processor-based system for encoding/decoding under the general described aspects.

FIG. 9 illustrates an embodiment of a first method under the described aspects.

FIG. 10 illustrates an embodiment of a second method under the described aspects.

FIG. 11 illustrates one embodiment of an apparatus under the described aspects.

### DETAILED DESCRIPTION

The embodiments described here are in the field of video compression and generally relate to video compression and video encoding and decoding more specifically aims at improving compression efficiency compared to existing video coding systems.

To achieve high compression efficiency, image and video coding schemes usually employ block-based prediction, including motion vector prediction, and transform to leverage spatial and temporal redundancy in the video content. Generally, intra or inter prediction is used to exploit the intra or inter frame correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

In the HEVC (High Efficiency Video Coding) video compression standard, motion compensated temporal prediction is employed to exploit the redundancy that exists between successive pictures of a video.

To do, a motion vector is associated to each prediction unit (PU), which is introduced now. Each CTU (Coding Tree Unit) is represented by a Coding Tree in the compressed domain. This is a quad-tree division of the CTU, where each leaf is called a Coding Unit (CU).

Each CU is then given some Intra or Inter prediction parameters (Prediction Info). To do so, it is spatially partitioned into one or more Prediction Units (PUs), each PU being assigned some prediction information. The Intra or Inter coding mode is assigned on the CU level.

Exactly one Motion Vector is assigned to each PU in HEVC. This motion vector is used for motion compensated temporal prediction of the considered PU.

In the Versatile Video Codec (VVC) developed by the JVET (Joint Video Exploration Team) group, a CU is no more divided into PU or TU, and some motion data is directly assigned to each CU. In this new codec design, a CU can be divided into sub-CU with a motion vector computed for each sub-CU.

In VVC, a geometric partitioning mode is supported for inter prediction. The geometric partitioning mode is signaled using a CU-level flag as one kind of merge mode, with other merge modes.

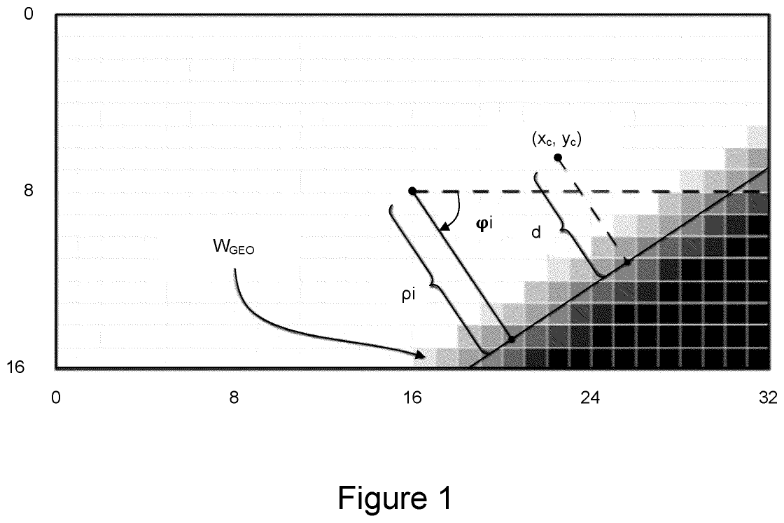

When this mode is used, a CU is split into two parts by a geometrically located straight line. The location of the splitting line is mathematically derived from the angle and offset parameters of a specific partition (FIG. 1). The angle φᵢ is quantized from between 0 and 360 degrees with a step equal to 11.25 degree (total 32). The description of a geometric split with angle φᵢ and distance ρᵢ is depicted in FIG. 1.

Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

P_{bi-pred}=((8−w)*P₀+w*P₁+4)>>3 (1)
Five weights are allowed in the weighted averaging bi-prediction, w∈{−2,3,4,5,10}. For each bi-predicted CU, the weight w is determined in one of two ways: 1) for a non-merge CU, the weight index is signaled after the motion vector difference, 2) for a merge CU, the weight index is inferred from neighboring blocks based on the merge candidate index. For low-delay pictures, all 5 weights are used. For non-low-delay pictures, only 3 weights (w∈{3,4,5}) are used. In the ECM (Enhanced Compression Model) software, the negative bi-predicted weights for non-merge mode {−2, 10} are replaced with positive weights {1, 7}.

### Template Matching Based BCW Index Derivation for Merge Mode

In the ECM software, the BCW index for merge coded CUs is derived based on template matching cost instead of being derived from neighboring blocks. Given a selected merge candidate, the TM cost values are calculated with different bi-prediction weights, and then, the bi-prediction weight with minimum TM cost value is used to predict the merge CU.

In addition, the bi-prediction weights for merge mode are extended from {−2, 3, 4, 5, 10} to {1, 2, 3, 4, 5, 6, 7}.

### Regression Based Affine Candidate Derivation

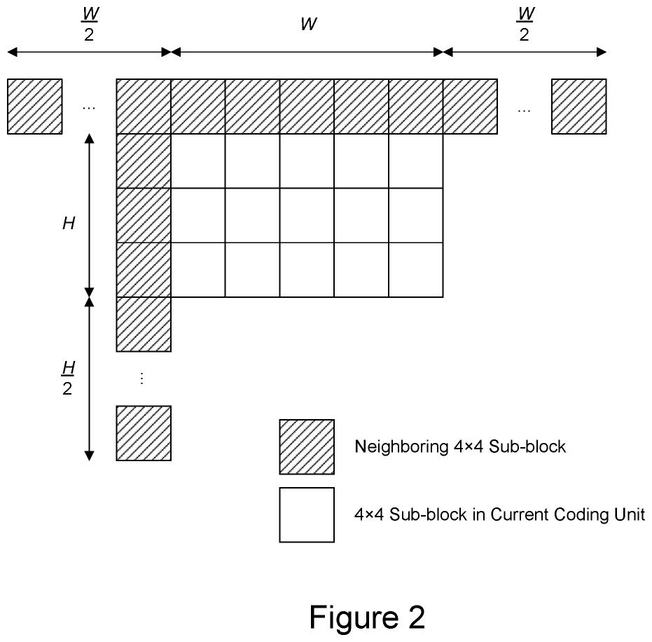

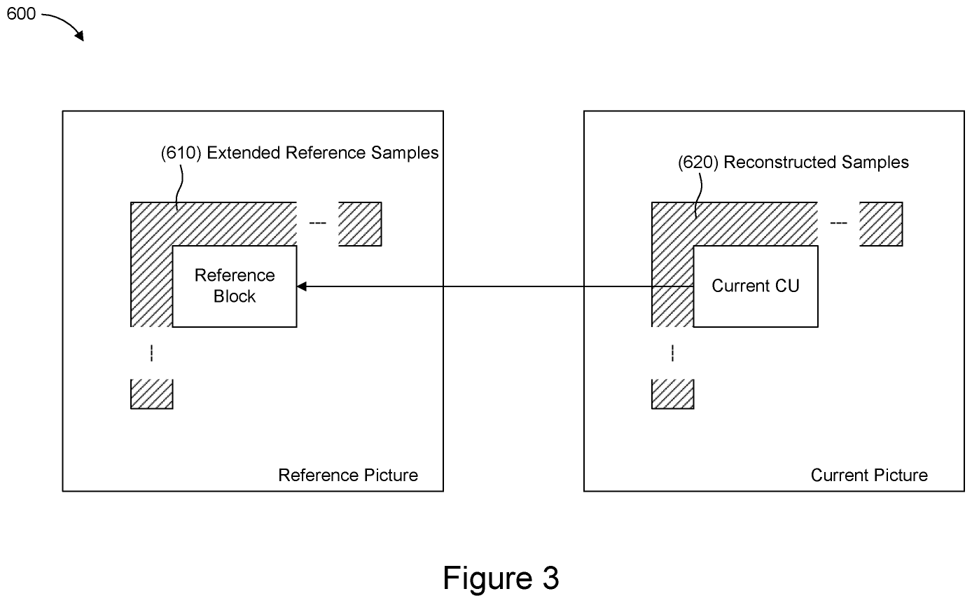

In the ECM software, the Regression based Motion Vector Field (RMVF) derivation method provides a new variety of subblock-based merge candidate. FIG. 2 shows the neighboring subblocks used for RMVF parameter derivation. The motion vectors and center positions from the neighboring subblocks of the current CU, as illustrated in FIG. 3, are used as the input to the linear regression process to derive a set of linear model parameters:

$$[ \begin{matrix}{MV}_{X \_ subPU} \\ {MV}_{Y \_ subPU}\end{matrix} ] = [ \begin{matrix}{a}_{xx} & {a}_{xy} \\ {a}_{yx} & {a}_{yy}\end{matrix} ] [ \begin{matrix}{X}_{subPU} \\ {Y}_{subPU}\end{matrix} ] + [ \begin{matrix}{b}_{x} \\ {b}_{y}\end{matrix} ]$$

The subblock motion field from a previous coded affine CU and the motion vectors from the adjacent subblocks of current CU are used as the input for the regression process. The predicted CPMVs (Control Point Motion Vectors) for current block are derived as output.

The regression based affine merge candidates are derived and added to the affine merge list. Subblock motion field from a previously coded affine CU and motion information from adjacent subblocks of a current CU are used as the input to the regression process to derive proposed affine candidates.

The GEO mode allows for coding a block with two partitions with an arbitrary splitting line. Each partition being predicted as regular uni-directional inter prediction. The BCW allows combining two uni-predictions into a bi-prediction using constant weighting for the whole block.

However, the existing solutions does not allow building bi-prediction with un-equal weights varying spatially over the current block.

It is proposed to modify the process for deriving the BCW weights to allow supporting bi-prediction with un-equal weights varying spatially over the current block. The spatially varying weights are derived using regression-based model computed with template made of neighboring reconstructed samples.

### Embodiment-1—Regression Based Bi-Prediction Weights

According to this embodiment, spatially varying weights for the current bi-predicted block are derived using regression-based method from template samples. It provides a bi-prediction weight w(x,y) for each sample located at position (x,y) in the current block. w(x,y) is defined as a parametric function that depends on parameters estimated from template samples. For instance, the parametric function is defined as follows, with parameters a₁,a₂,b.

w(x,y)=a₀·x+a₁·y+b (2)

The inputs to the regression-based process are (600):
The two extended uni-predictions P_{i=0,1} (motion compensation of the reference block extended with template) (610)
The reconstructed samples of the template (620)

The regression aims at minimizing a distance (for instance Mean-square-error, LSM) between reconstructed samples of the template and the prediction samples of the template derived from the two uni-predictions Pᵢ templates. The output of the regression-based process are the parameters {a₀, a₁, b}.

The bi-prediction sample at position (x,y) is obtained as follows:

P_{bi-pred}(x,y)=(1−w(x,y))×P₀(x,y)+(w(x,y))×P₁(x,y) (3)

The reconstructed template is made of reconstructed samples above and left to the current block. In a variant, the template is extended above-right and left-bottom with additional samples, the extension length can be a relative proportion of the current block size (ex: width extension equal to half of the current block width). The number of lines and columns of the templates may be one line/column or more. In a variant, the number of lines of the template above (and the number of columns of the template at left) are extended with additional samples, the extension length can be a relative proportion of the current block height (or width respectively). In another variant, the template is made of reconstructed samples above or left, or above and left together to the current block, and the template selection could be signaled in the bitstream.

In another variant, the bias parameter {b} is set to zero (not part of the regression process).

In another variant, the coefficients a_{1=0,1} and b are found using a LSM with adding some constraints: for example, the weights deduced for a particular position should be inside an interval (typically: [−2/8;10/8]). The equation is solved using constrained Least Square Method.

### Embodiment-2—Control of the Regression-Based Process

According to this embodiment, the output of the value of w(x,y) is further clipped. For example, the value of w(x,y) cannot exceed the minimum/maximum values obtained with the regular BCW indexes (ex: [−2/8;10/8] or [1/8;7/8]). In a variant, the minimum/maximum values of w(x,y) are [0;1]. That is if the precision is 1/32, the integer values range is [0;32], 0 means w=0.0 and 32 means w=1.0. In another example, minimum and maximum values are 1/32 and 31/32 respectively. In another variant, the minimum value may be negative, and the maximum value may exceed 1.0 (ex: maximum value is 35 and the precision is 1/32). In a variant, the maximum and minimum values may depend on the POC (Picture Order Count) values of the reference picture used for the prediction. For example, when all the pictures used for the prediction are in the same temporal direction compared to the current picture (e.g., all in the past, or all in the future), then a maximum value greater than 1.0 may be allowed (e.g., maximum value is 48 and the precision is 1/32), and when the reference pictures are not all in the same direction then the values may be limited between 0.0 and 1.0 (i.e. between 0 and 32 with precision of 1/32).

In a variant, the values of w(x,y) are rounded to the closest integer value. The precision may be the same as regular BCW (1/8) or may be extended/reduced (ex: 1/16, 1/32 or 1/4).

In another variant, if the value of w(x,y) exceeds some pre-defined (minimal or maximal) value M for any of value of (x,y) in the current block, or for pre-determined locations (ex: (x,y) corner coordinates of the current CU, and/or CU center), then the regression-based method is not used and the bi-prediction weights are set to default constant value (ex: w=0,5) or the regular BCW method is used. In another variant, the value of M is a function depending on the inherited or decoded BCW index. For example, if the BCW weights ae %, %, then the refine range is between 1/8 to 3/8 for weighting %, and 5/8 to 1 for weighting %.

In another variant, the regression-based method is used in merge mode only. In another variant, a flag is signaled in the bitstream at CU level to indicate if the regression-based method is used.

### Embodiment-3—Bi-Prediction Weights Derived when Sub-Block Prediction is Used

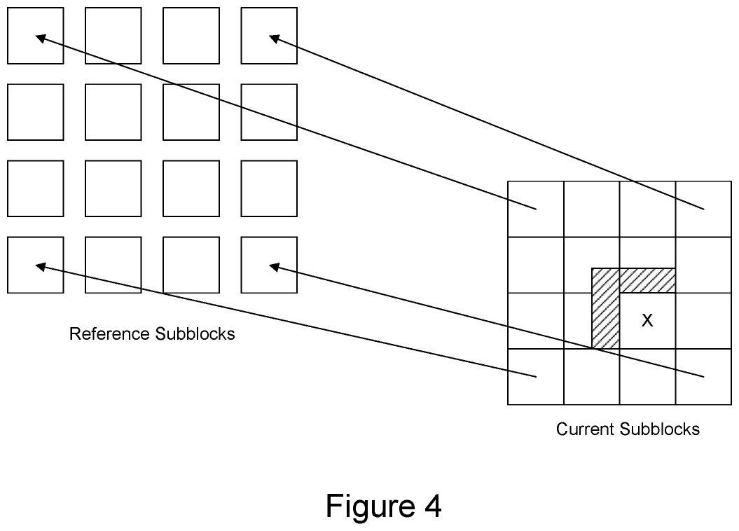

In the state-of-art of video coding, a CU can be divided into subblocks, with each subblock having its own inter prediction (its own motion vectors and/or reference blocks) (such as the sbTMVP or the affine mode in VVC). This is illustrated in FIG. 4.

In this embodiment, the method described above is applied per subblock. However, it would require waiting so that the reconstructed samples of the subblock template are available, which would introduce additional latency.

In another embodiment, the mode is disabled for a CU when the CU is divided into subblocks and that each subblock uses its own inter prediction (its own motion vectors and/or reference blocks) (such as the sbTMVP or the affine mode in VVC).

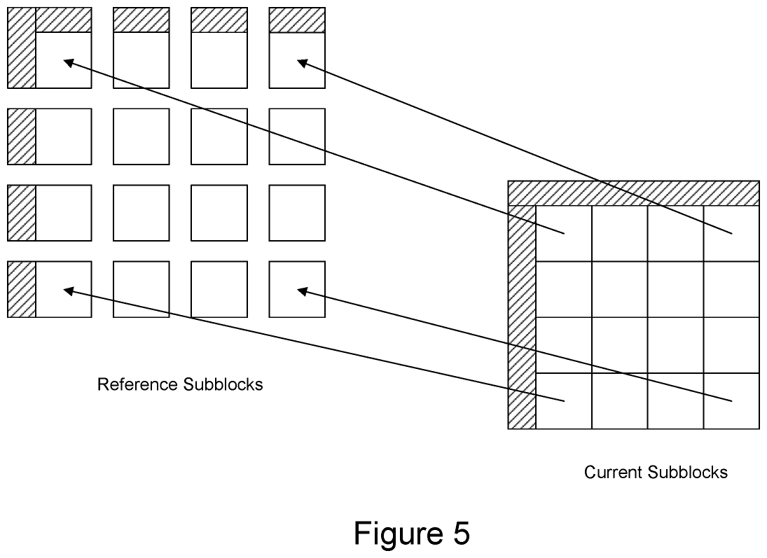

In another embodiment, the template for reference pictures is the concatenation of the templates of the reference top and left subblocks, as illustrated in FIG. 5. For the top-left reference subblock, the top and left template samples are used. For the other top reference subblocks, only the top template samples are used. For the other left reference subblocks, only the left template samples are used.

### Embodiment-4—Regression-Based on BCW Indexes

According to this embodiment, the regression is performed using the BCW indexes. For each neighboring sub-blocks, the best bi-prediction BCW weight index “idx” is computed (minimizing the TM cost over the template intersecting the sub-block, see embodiment 3) and is associated to the sample in the template. The regression model allows to derive the index value for each sample (x,y) in the current CU (4):

idx(x,y)=a₀·x+a₁·y+b (4)

The value idx(x,y) can be rounded to the closest integer. The value of w(x,y) is the weight associated with BCW index idx(x,y).

### Embodiment-5—Multi-Model Weights

In an embodiment, the parameters controlling w(x,y) depend also on the sample values of P0 and P1.

In one variant, the sample range is divided in intervals (for instance, 8 intervals of 128 values for a 10-bit signal). The intervals of P0 and P1 are identified, and for each couple of intervals (i0,i1), 1 parametric function wᵢ₀ᵢ₁(x,y) is applied. This is illustrated in the table below, where depending on the interval of P0 and P1, various weights are used.

The parameters of wᵢ₀ᵢ₁(x,y) are computed from the template samples P0,P1, such that P0 belongs to interval i0 and P1 belongs to interval i1.

| | P1 | | | | | | | |
|---|---|---|---|---|---|---|---|---|
| P0 | 0-128 | 128-256 | 256-384 | 384-512 | 512-640 | 640-768 | 768-896 | 896-1024 |
| 0-128 | w₀₀(x, y) | . . . | . . . | . . . | . . . | . . . | . . . | w₀₇(x, y) |
| 128-256 | . . . | . . . | . . . | . . . | . . . | . . . | . . . | . . . |
| 256-384 | . . . | . . . | . . . | . . . | . . . | . . . | . . . | . . . |
| 384-512 | . . . | . . . | . . . | . . . | . . . | . . . | . . . | . . . |
| 512-640 | . . . | . . . | . . . | . . . | . . . | . . . | . . . | . . . |
| 640-768 | . . . | . . . | . . . | . . . | . . . | . . . | . . . | . . . |
| 768-896 | . . . | . . . | . . . | . . . | . . . | . . . | . . . | . . . |
| 896-1024 | w₇₀(x, y) | . . . | . . . | . . . | . . . | . . . | . . . | w₇₇(x, y) |

In a simplified variant, two ranges are considered for P0 and P1, P0<L0 or P0>=L0, P1<L1 or P1>=L1, L0/L1 being for instance the median of P0/P1 in the template, or ½ of the average of P0/P1 in the template. So only four weight models are used, w₀₀,w₀₁,w₁₀,w₁₁.

In another simplified variant, two models for w(x,y) are used, one model used when (P0+P1)<L, one model used when (P0+P1)>=L, L being for instance the median of (P0+P1) in the template, or % of the average of (P0+P1) in the template.

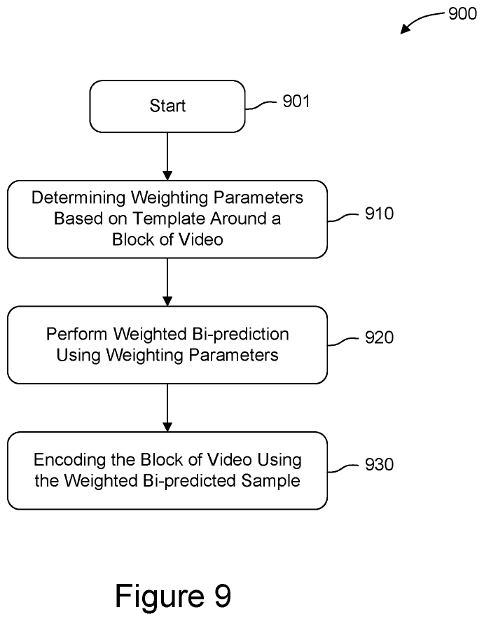

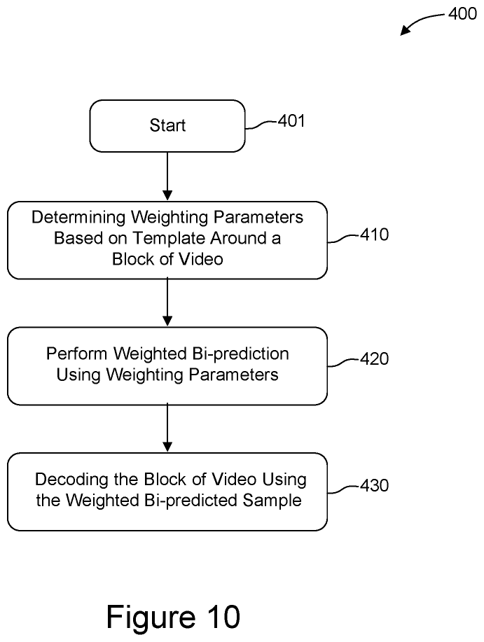

One embodiment of a method 900 under the general aspects described here is shown in FIG. 9. The method commences at start block 901 and control proceeds to block 910 for determining weighting parameters for a sample of a block of video based on a template of samples neighboring the block of video. Control proceeds from block 910 to block 920 for performing weighted bi-prediction of the sample using said determined weighting parameters. Control proceeds from block 920 to block 930 for encoding the block of video using said weighted bi-predicted sample One embodiment of a method 400 under the general aspects described here is shown in FIG. 10. The method commences at start block 401 and control proceeds to block 410 for determining weighting parameters for a sample of a block of video based on a template of samples neighboring the block of video. Control proceeds from block 410 to block 420 for performing weighted bi-prediction of the sample using said determined weighting parameters. Control proceeds from block 420 to block 430 for decoding the block of video using said weighted bi-predicted sample

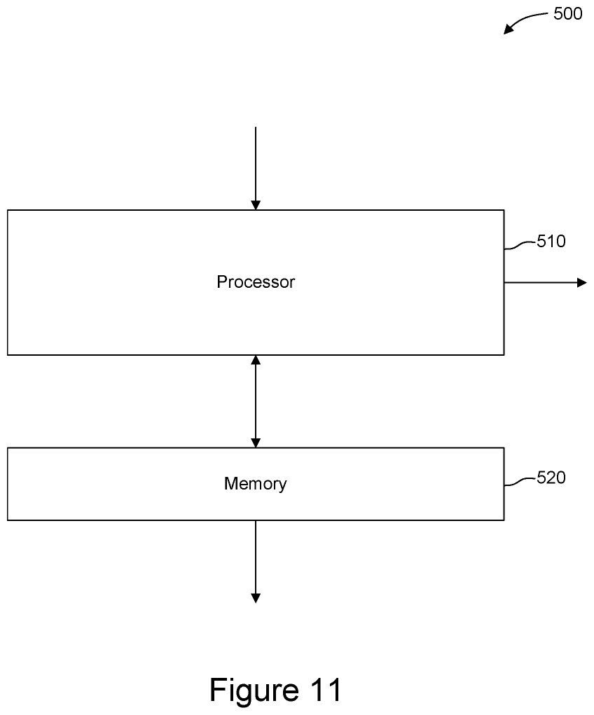

FIG. 11 shows one embodiment of an apparatus 500 for encoding, decoding, compressing or decompressing video data using coding of intra geometric partition mode with template matching. The apparatus comprises Processor 510 and can be interconnected to a memory 520 through at least one port. Both Processor 510 and memory 520 can also have one or more additional interconnections to external connections.

Processor 510 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

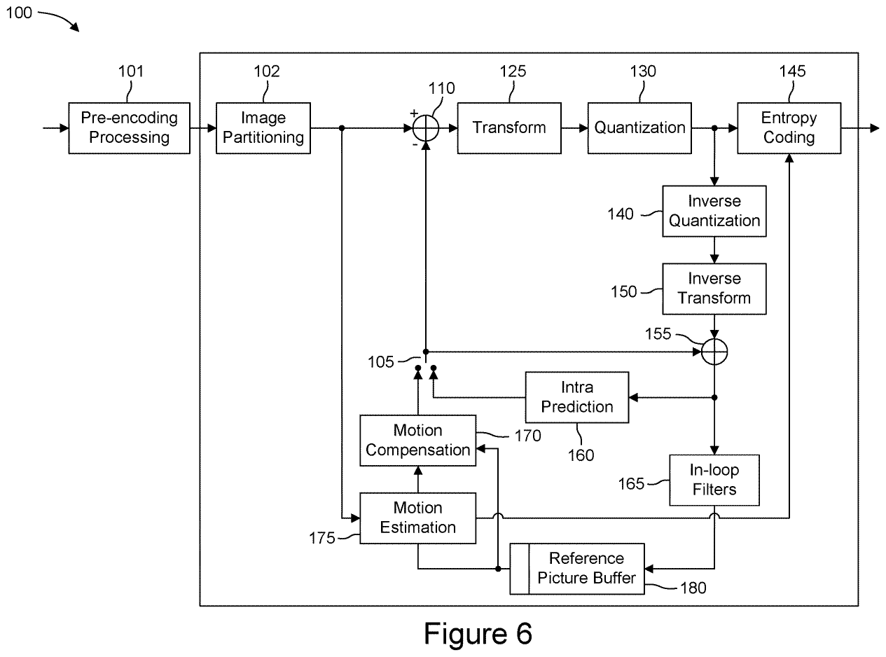

The aspects described and contemplated in this application can be implemented in many different forms. FIGS. 6, 7, and 8 provide some embodiments, but other embodiments are contemplated and the discussion of FIGS. 6, 7, and 8 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

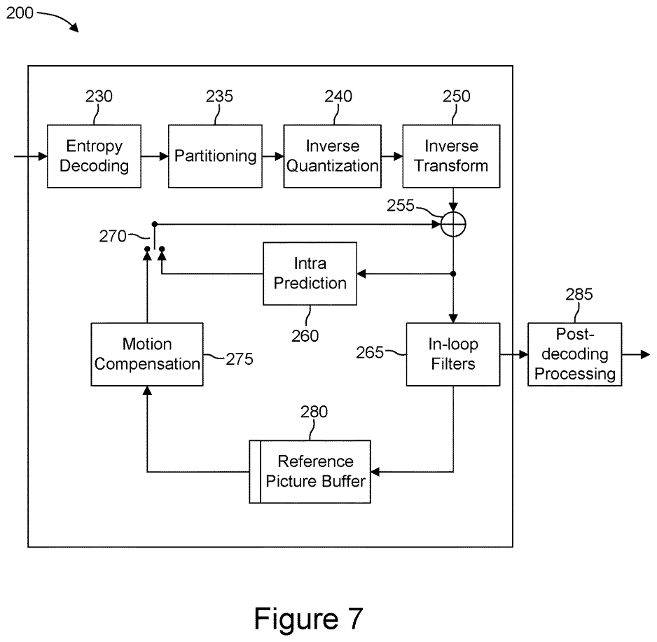

Various methods and other aspects described in this application can be used to modify modules, for example, the intra prediction, entropy coding, and/or decoding modules (160, 260, 145, 230), of a video encoder 100 and decoder 200 as shown in FIG. 6 and FIG. 7. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 6 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 7 illustrates a block diagram of a video decoder 200. In the decoder 200, a bitstream is decoded by the decoder elements as described below. Video decoder 200 generally performs a decoding pass reciprocal to the encoding pass as described in FIG. 6. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

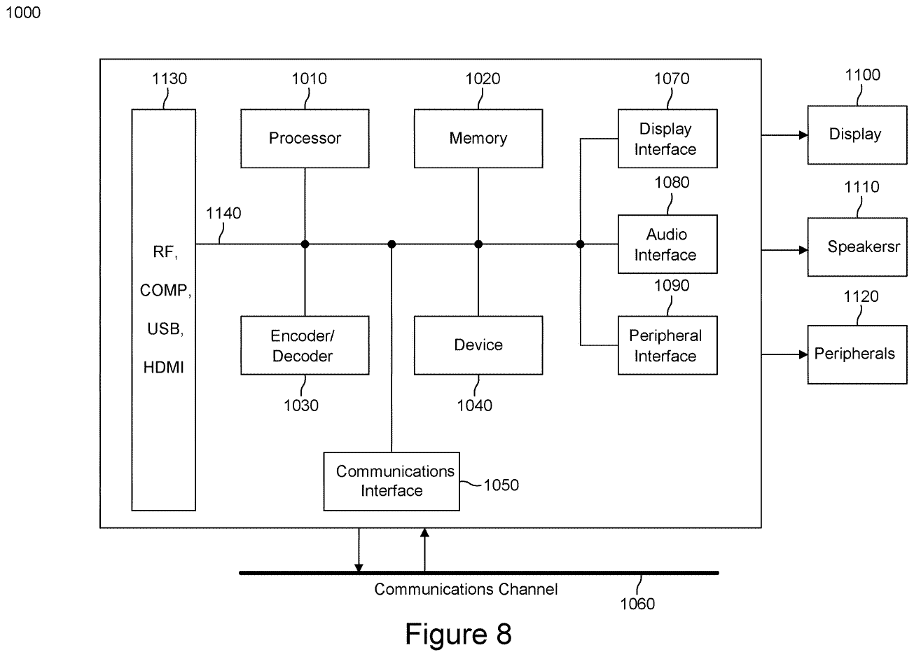

FIG. 8 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 8, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

At least one embodiment comprises encoding or decoding a video block by using bi-prediction with spatially varying weights per sample based on a template of samples around the video block.

At least one embodiment comprises the above embodiment using regression to derive weights for the bi-prediction.

At least one embodiment further comprises determining of weighting parameters based on minimizing a distance between reconstructed samples of the template and prediction samples of the template.

At least one embodiment further comprises the above embodiments wherein a weight for a sample is rounded, clipped, limited in range, or set to a specified value based on position or weight value.

At least one embodiment further comprises the above embodiments wherein determination of weighting parameters is done using regression in merge mode only.

At least one embodiment comprises the above embodiments wherein a template comprises a plurality of samples neighboring the video block, the plurality of samples taken from along a top row or a left row or both.

At least one embodiment comprises any encoding or decoding operation based on the above operations.

At least one embodiment comprises performing encoding or decoding with the aforementioned methods on a sub-block.

At least one embodiment comprises a bitstream or signal that includes one or more of the described syntax elements, or variations thereof.

At least one embodiment comprises a bitstream or signal that includes syntax conveying information generated according to any of the embodiments described.

At least one embodiment comprises creating and/or transmitting and/or receiving and/or decoding according to any of the embodiments described.

At least one embodiment comprises a method, process, apparatus, medium storing instructions, medium storing data, or signal according to any of the embodiments described.

At least one embodiment comprises inserting in the signaling syntax elements that enable the decoder to determine decoding information in a manner corresponding to that used by an encoder.

At least one embodiment comprises creating and/or transmitting and/or receiving and/or decoding a bitstream or signal that includes one or more of the described syntax elements, or variations thereof.

At least one embodiment comprises a TV, set-top box, cell phone, tablet, or other electronic device that performs transform method(s) according to any of the embodiments described.

At least one embodiment comprises a TV, set-top box, cell phone, tablet, or other electronic device that performs transform method(s) determination according to any of the embodiments described, and that displays (e.g., using a monitor, screen, or other type of display) a resulting image.

At least one embodiment comprises a TV, set-top box, cell phone, tablet, or other electronic device that selects, bandlimits, or tunes (e.g., using a tuner) a channel to receive a signal including an encoded image, and performs transform method(s) according to any of the embodiments described.

At least one embodiment comprises a TV, set-top box, cell phone, tablet, or other electronic device that receives (e.g., using an antenna) a signal over the air that includes an encoded image, and performs transform method(s).

1. A method, comprising:
determining spatially varying with affine model weighting parameters for a sample of a block of video based on a template of samples neighboring the block of video;
performing weighted bi-prediction of the sample using said determined weighting parameters; and,
encoding the block of video using said weighted bi-predicted sample.

2. An apparatus, comprising:
a memory, and
a processor, configured to:
determine spatially varying with affine model weighting parameters for a sample of a block of video based on a template of samples neighboring the block of video;
perform weighted bi-prediction of the sample using said determined weighting parameters; and,
encode the block of video using said weighted bi-predicted sample.

3. A method, comprising:
determining spatially varying with affine model weighting parameters for a sample of a block of video based on a template of samples neighboring the block of video;
performing weighted bi-prediction of the sample using said determined weighting parameters; and,
decoding the block of video using said weighted bi-predicted sample.

4. An apparatus, comprising:
a memory, and
a processor, configured to:
determine spatially varying with affine model weighting parameters for a sample of a block of video based on a template of samples neighboring the block of video;
perform weighted bi-prediction of the sample using said determined weighting parameters; and,
decode the block of video using said weighted bi-predicted sample.

5. The apparatus of claim 2, wherein the determining of weighting parameters comprises minimizing a distance between reconstructed samples of the template and prediction samples of the template.

6. The apparatus of claim 5, wherein minimizing a distance comprises a regression analysis.

7. The method of claim 1, wherein the determining of weighting parameters comprises determination of a mean square error.

8. The method of claim 1, wherein a weight for a sample is rounded, clipped, limited in range, or set to a specified value based on position or weight value.

9. The method of claim 1, wherein determination of weighting parameters is done using regression in merge mode only.

10. The method of claim 1, performed per subblock.

11. The apparatus of claim 2, wherein a template comprises a plurality of samples neighboring the video block, the plurality of samples taken from along a top row or a left row or both.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 1, for playback using a processor.

14. (canceled)

15. A computer program product comprising instructions which, when the program is executed by a computer, cause the computer to carry out the method of claim 3.

16. The apparatus of claim 4, wherein the determining of weighting parameters comprises minimizing a distance between reconstructed samples of the template and prediction samples of the template.

17. The apparatus of claim 5, wherein minimizing a distance comprises a regression analysis.

18. The method of claim 3, wherein the determining of weighting parameters comprises determination of a mean square error.

19. The method of claim 3, wherein a weight for a sample is rounded, clipped, limited in range, or set to a specified value based on position or weight value.

20. The method of claim 3, wherein determination of weighting parameters is done using regression in merge mode only.

21. The apparatus of claim 4, wherein a template comprises a plurality of samples neighboring the video block, the plurality of samples taken from along a top row or a left row or both.
